(19) United States
(12) Patent Application Publication
(10) Pub. No.: US 2011/0161616 A1
(43) Pub. Date: Jun. 30, 2011

(54) ON DEMAND REGISTER ALLOCATION AND DEALLOCATION FOR A MULTITHREADED PROCESSOR

(75) Inventors: David Tarjan, Santa Clara, CA (US); Kevin Skadron, Charlottesville, VA (US)

(73) Assignee: NVIDIA CORPORATION, Santa Clara, CA (US)

(21) Appl. No.: 12/649,238

(22) Filed: Dec. 29, 2009

(51) Int. Cl. G06F 12/02; G06F 12/08

(52) U.S. Cl. 711/170; 711/203; 711/E12.002; 711/E12.016

(57) ABSTRACT

A system for allocating and de-allocating registers of a processor. The system includes a register file having plurality of physical registers and a first table coupled to the register file for mapping virtual register IDs to physical register IDs. A second table is coupled to the register file for determining whether a virtual register ID has a physical register mapped to it in a cycle. The first table and the second table enable physical registers of the register file to be allocated and de-allocated on a cycle-by-cycle basis to support execution of instructions by the processor.

### FIELD OF THE INVENTION

The present invention is generally related to computer systems.

### BACKGROUND OF THE INVENTION

Modern GPUs are massively parallel processors emphasizing parallel throughput over single-thread latency. Graphics shaders read the majority of their global data from textures and general-purpose applications written for the GPU also generally read significant amounts of data from global memory. These accesses are long latency operations, typically hundreds of clock cycles.

In many programs, there is little live data in the registers while waiting for data to return from global memory. However, when the data (e.g., texture, etc.) is returned the resulting computation requires a larger number of registers. On one set of shaders the average fraction of unused register is close to 60%. The maximum number of registers required during the lifetime of the program, however, is currently what is allocated for each thread context.

Modern GPUs deal with the long latencies of texture accesses by having a large number of threads active concurrently. They can switch between threads on a cycle by cycle basis, covering the stall time of one thread with computation from another thread. To support this large number of threads, GPUs have to have very large register files. Relying on multithreading for latency tolerance in this fashion allows the GPU to minimize area dedicated to on-chip caching and maximize the number of processing elements provided on the chip. In fact, this approach of using multithreading to tolerate latency is not limited to the GPU and could also be applied in a multicore CPU. In either case, while waiting for long-latency memory references, many or most of a thread's registers do not contain useful data. When aggregated over the entire chip, the amount of idle register file resources is considerable and the associated area could be put to other uses.

Thus, a need exists for a solution that can yield improved hardware utilization of a multithreaded processor.

### SUMMARY OF THE INVENTION

Embodiments of the present invention implement register allocation and de-allocation functionality to increase the utilization of the register file resources of a GPU or CPU for higher performance and/or lower power requirements.

In one embodiment, the present invention is implemented as a system for allocating and de-allocating registers of a processor. The system includes a register file having plurality of physical registers and a first table (e.g., a logical register to physical register table) coupled to the register file for mapping virtual register IDs to physical register IDs. A second table (e.g., virtual register mapped to a physical register table) is coupled to the register file for determining whether a virtual register ID has a physical register mapped to it in a cycle. The first table and the second table enable physical registers of the register file to be allocated and de-allocated on a cycle-by-cycle basis to support execution of instructions by the processor.

In this manner, embodiments of the present invention implement a system for allocating registers to threads on demand, such as only at the time the registers are actually written, and de-allocating them as early as possible. By being able to do load-balancing between the many threads which are executing simultaneously on a GPU or CPU, the size of the register file needed for a given number of threads can be reduced by a factor of two, or alternatively, double the number of simultaneously executing threads.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a computer system in accordance with one embodiment of the present invention.

FIG. 2 shows a register allocation de-allocation system in accordance with one embodiment of the present invention.

FIG. 3 shows a register allocation de-allocation system that includes a table for tracking a number of data consumers in accordance with one embodiment of the present invention.

FIG. 4 shows a computer system in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### NOTATION AND NOMENCLATURE

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

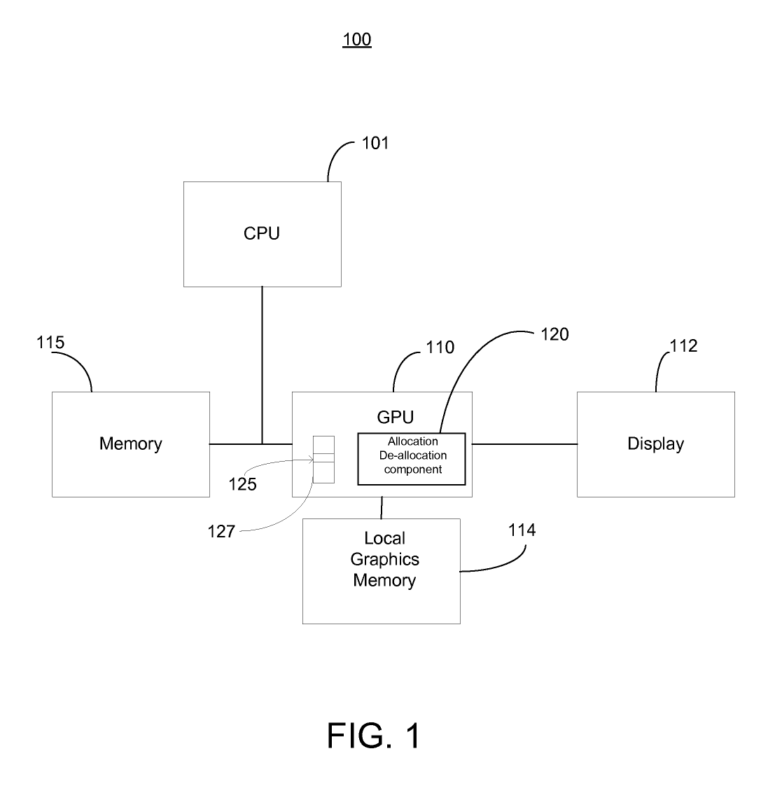

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Platform:

FIG. 1 shows a computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 is coupled to a display 112. The GPU 110 is shown including an allocation/de-allocation component 120 for just-in-time register allocation for a multithreaded processor. A register file 127 and an exemplary one of the plurality of registers (e.g., register 125) comprising the register file is also shown within the GPU 110. One or more additional GPUs can optionally be coupled to system 100 to further increase its computational power. The GPU(s) 110 is coupled to the CPU 101 and the system memory 115. System 100 can be implemented as, for example, a desktop computer system or server computer system, having a powerful general-purpose CPU 101 coupled to a dedicated graphics rendering GPU 110. In such an embodiment, components can be included that add peripheral buses, specialized graphics memory, IO devices, and the like. Similarly, system 100 can be implemented as a handheld device (e.g., cellphone, etc.) or a set-top video game console device such as, for example, the Xbox®, available from Microsoft Corporation of Redmond, Wash., or the PlayStation3®, available from Sony Computer Entertainment Corporation of Tokyo, Japan.

It should be appreciated that the GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

### EMBODIMENTS OF THE INVENTION

Embodiments of the present invention implement register allocation and de-allocation functionality to increase the utilization of the register file resources of a GPU or CPU for higher performance and/or lower power requirements. Conventionally, the average utilization of registers on a GPU is low due to poor temporal locality of data accesses and frequent stalls waiting on long latency references to global memory. This is of particular concern because register files in GPUs are large to accommodate a large number of threads. Similarly, multicore CPUs are likely to experience the same problems as they reduce core complexity to allow a larger number of simpler cores, and compensate for reduced per-thread instruction-level parallelism and poor temporal locality with thread parallelism.

To increase the utilization of the register file for higher performance and/or lower power, embodiments of the present invention utilize a hardware mechanism for allocating registers to threads on demand—i.e., only at the time the registers are actually written—and de-allocating them as early as possible. By being able to do load-balancing between the many threads which are executing simultaneously on a GPU, embodiments of the present invention can reduce the size of the register file needed for a given number of threads by, for example, a factor of two or double the number of simultaneously executing threads.

Accordingly, embodiments of the present invention include systems configured for just-in-time register allocation for a multithreaded processor. These systems dynamically allocate registers to a thread when they will be written (e.g., as opposed to when the thread is created), and de-allocate registers that are not currently needed so that the registers can be allocated to other threads. This feature reduces the necessary size of the primary, high-speed register file to correspond to average utilization across all threads, rather than max footprint across all threads.

It should be noted that an important aspect of the above described system is a solution for a case when the required register footprint of dependent threads is larger than the available resources. In such cases, deadlock can occur. Embodiments of the present invention avoid this problem by allocating “excess” registers to an alternative location (e.g., which may be a less expensive, dedicated, secondary register file) or simply space in memory (e.g., effectively spilling excess registers to cache).

To enable registers to be allocated and de-allocated on a cycle-by-cycle basis, embodiments of the present invention introduce structures that implement register renaming. In one embodiment, to decouple the virtual number of registers from the physical registers in use at any given time, an extra level of indirection is introduced between the register IDs supplied by the instruction and the physical register id used to index the register file. The logical to physical (e.g., Log 2Phys) table maps virtual register IDs to physical IDs, acting in the function of a rename map. A second structure (e.g., called ValReg) is utilized to determine whether a virtual register ID has a physical register mapped to it in that cycle. It should be noted that this feature is different from conventional register renaming (e.g., as in an out-of-order microprocessor), where each register always has a physical register mapped to it. The above described structures and how they operate are now described in detail below.

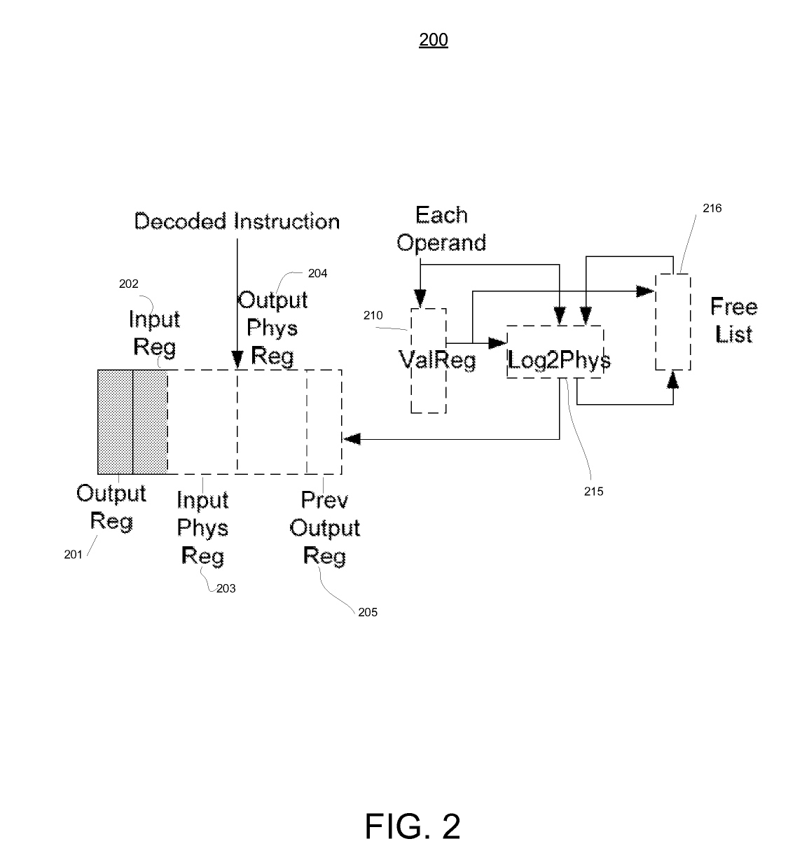

FIG. 2 shows a register allocation de-allocation system 200 in accordance with one embodiment of the present invention. As depicted in FIG. 2, system 200 includes a plurality of registers 201-205, a ValReg table 210, a Log 2Phys table 215, and a free list table 216.

In the FIG. 2 embodiment, at thread start, each thread begins with no physical registers assigned to it and its ValReg table 210 reset to all false and its all Log 2Phys table 215 entries being entry/invalid. As instructions get decoded, each of the instructions check the ValReg table to see whether their logical output register has a physical register assigned to it. If that is the case, the instruction then looks up the physical register number in the Log 2Phys table. If no physical register is assigned to the logical output register, then the hardware takes a register from the free list and assigns it to that logical register. The ValReg entry for that register is set to true and the physical register number is written to the appropriate entry in the Log 2Phys table. These events occur before the instruction actually issues.

In parallel, the physical register number for the logical input registers are also read from the Log 2Phys table and the ValReg table is checked. In a special case where the ValReg table indicates that one or both of the inputs is invalid, a special default value (e.g., usually zero) is supplied to the instruction. It should be noted that this case can only occur if the logical register has not been written to yet, in which case most architectures assume either a default value or treat the read as undefined behavior. This feature is only needed to deal with buggy but theoretically legal programs.

With respect to registered de-allocation, de-allocation has to work differently depending on whether the processor is using strict in-order issue or out-of-order issue or in-order issue with the possibility of replaying instructions. We will first describe the simpler strict in-order case and then the more complicated out-of-order case.

For a strictly in-order processor, in one embodiment, physical registers can be de-allocated when an instruction writes a new value in the logical register they have been assigned to. In-order execution guarantees that the last consumer of the previous value has already issued by the time any later instruction writes a new value into the logical register.

Prior to assigning a new physical register number to a logical register, the previous physical register number that was assigned to this logical register is read out. This prior physical register number is stored in addition to the physical register number of the input and output registers in the instructions scoreboard entry. When the instruction issues, the old physical register number can be put back on the free list 216.

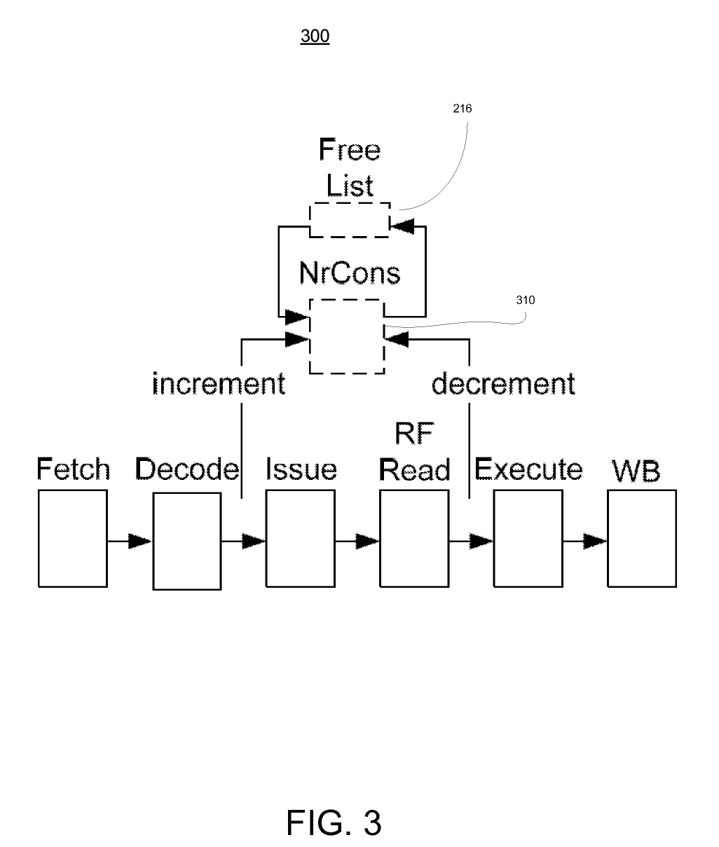

FIG. 3 shows a register allocation de-allocation system 300 that includes a table for tracking a number of data consumers in accordance with one embodiment of the present invention.

If a processor is using out-of-order execution, or a variant of in-order execution with unpredictable delays between when an instruction is issued and when it is actually executed, the hardware cannot be sure of the fact that the last consumer of the previous value of a logical register has already issued. Additional hardware is needed to keep track of when it is safe to recycle a physical register.

In one embodiment, the present invention implements a new table NrCons 310 with one entry per physical register is needed, with each entry being a small counter for the number of consumers of the current value in the physical register. The counter is set to zero when the physical register is taken off the free list. After each operand has read out the physical register number from the Log 2Phys table it increments the appropriate counter by one. When an instruction actually executes it uses the physical register numbers of its inputs to decrement the appropriate counters by one. If a counter reaches zero after a decrement operation it is put back on the free list.

It should be noted that, in one embodiment, a physical register is only put back on the free list when it has been overwritten in the log 2phys table AND its counter is at zero. Else a register with a valid value could be recycled just before another instruction which would read that value is decoded and accesses the log 2phys table. Each entry in the NrCons table needs a single bit (in addition to the counter), which is set when a physical register is taken off the free list and is cleared by the instruction which writes a new value into the logical register that the physical register is mapped to. So the action sequence is the same as in the in-order case, PLUS the writing instruction clears the bit in the NrCons table and when the counter reaches zero AND the bit is cleared is the physical register put back on the free list.

With respect to register file size, even though just-in-time register allocation reduces the total number of allocated registers in many cases, it is possible that all threads execute in phase and reach their maximum register occupancy at the same time.

In one embodiment, if threads can have dependencies in execution or retirement, register storage must be large enough to accommodate all threads at peak occupancy. There are two possible solutions in this case.

A first solution is to provision the register file for this worst case, but put inactive rows or regions of the register file RAM in a low-leakage state. One common solution for this is the addition of a sleep transistor as a header or footer on the RAM cells of the idle registers. Such a solution has been described in many forms. Such a solution reduces the average power draw of the processor. Reducing the average power draw is especially valuable for systems which have a battery as their power source, as it can extend the runtime of such a system. Lower average power draw is also valuable for systems which are limited by average power density, such as certain types of embedded systems and systems being deployed in data centers, not peak instantaneous power. Lastly, lower average power can also be used to make the cooling solution of a processor be quieter, which improves user satisfaction. It should be noted that this solution can be applied to any embodiment of the present invention.

A second solution is to allow some registers to reside elsewhere than the primary register RAM. One embodiment is to allow “spillover” register contents to reside in a cache, preferably the first-level data cache. The Log 2Phys table for any logical register can point to a memory address instead of a register. This requires the addition of a single bit per entry in the Log 2Phys table to indicate whether each registers value is currently in a register or is stored in a cache, as well as a single register per core to hold the base pointer to memory at which spilled registers are stored. The register ID can then be treated as an offset to the base pointer to calculate the actual address of a spilled register. A second embodiment is to have a secondary register file that is optimized for the necessary worst-case capacity and minimal area, presumably at the expense of speed. In either case, when capacity is required beyond that of the primary register file, some logical registers are allocated or migrated to the alternate location. Several solutions for accomplishing this are now described.

One solution is to allocate registers in the primary storage when possible, but when no register is available in the primary register storage, simply allocate in the secondary location. There is no attempt to migrate logical registers so that the most frequently accessed values reside in the primary storage. This simply requires two free lists, and a bit to indicate when the primary-storage free list is empty.

Another solution is to identify threads that will be stalled for a long period of time while waiting for a reference to distant memory, and bulk copy some or all of such threads' entire register contents out to the secondary storage. This allows those threads' registers in the primary register file to be returned to the free list for threads with expanding register footprints. Such identification requires the implementation of an additional table of stalled threads. One embodiment of this is as follows. When a thread cannot make forward progress because it is waiting on outstanding memory references, this can be detected because instruction issue cannot find a new instruction to issue, or all issue slots are full. The issue logic enters this thread's ID in the table (or in the specific case of the NVIDIA™ GPU architecture, it can enter the warp number). When a result returns for this thread or warp, that thread or warp entry is removed.

When register capacity is needed, an entry can be chosen from the table and all currently allocated registers can be migrated to secondary storage and the Log 2Phys table updated, from which they can be accessed directly during future computation, or swapped back into the primary register file when some other thread vacates it (e.g., due to completion or migration). In one embodiment, to avoid having such bulk transfers delay progress of actively executing threads, such transfers have a lower priority for access to the Log 2Phys table unless the primary free list is too short.

Yet another solution for actively migrating logical registers to the alternate locations is to actively migrate registers so that the most frequently accessed values reside in the primary storage. In one embodiment, this is accomplished by using “decay counters” (e.g., counting the time since last reference). Registers in primary storage that are live but have not been accessed for some time suggests they will not be accessed for a long time yet. Such registers are identified and copied out to the secondary storage. Registers from secondary storage that are being used frequently are identified and migrated into the vacated primary location.

In addition to per-register decay counters, the above-described solution requires a unit that checks the counter value on every secondary-register-file access and remembers the register with the minimum counter value, or any register with a sufficiently low value, and a “register-swap” unit.

The register swap unit operates as follows. When a register's counter in primary storage overflows, a register is allocated in secondary storage and the primary register is copied. Once the copy is complete, the Log 2Phys table is updated. The vacated register ID is not placed on the free list, but is stored in a special register. At this point, the previously-identified register in the secondary storage with the minimum counter value is copied into the vacated primary register, and when the copy is complete, the Log 2Phys table is updated and the vacated secondary register is placed on the free list. The necessary traffic to the Log 2Phys table may require an additional read and write port to avoid interfering with normal operation, else normal instruction flow will stall on such swaps.

It should be noted that if threads are fully independent, the situation is much more straightforward. The register file can just have a capacity less than the worst-case occupancy, and a thread that cannot allocate a register simply stalls. However, it is preferable that there always exists enough free registers so that at least one warp can always make progress. The easiest way to ensure this is to ensure that one thread always has its full allocation.

With respect to the use of final read annotations, in one embodiment, it is possible for the compiler to identify when a thread reads a register for the last time, and that register is therefore dead. Instead of waiting for the register to eventually be overwritten later in the thread, or for the thread to complete, this physical register can be reclaimed immediately if the final read is indicated using a special annotation on the instruction. This requires the ability to annotate each instruction type with a bit for each operand to indicate whether it is a last read, which in turn requires the necessary number of available bits in the instruction encoding.

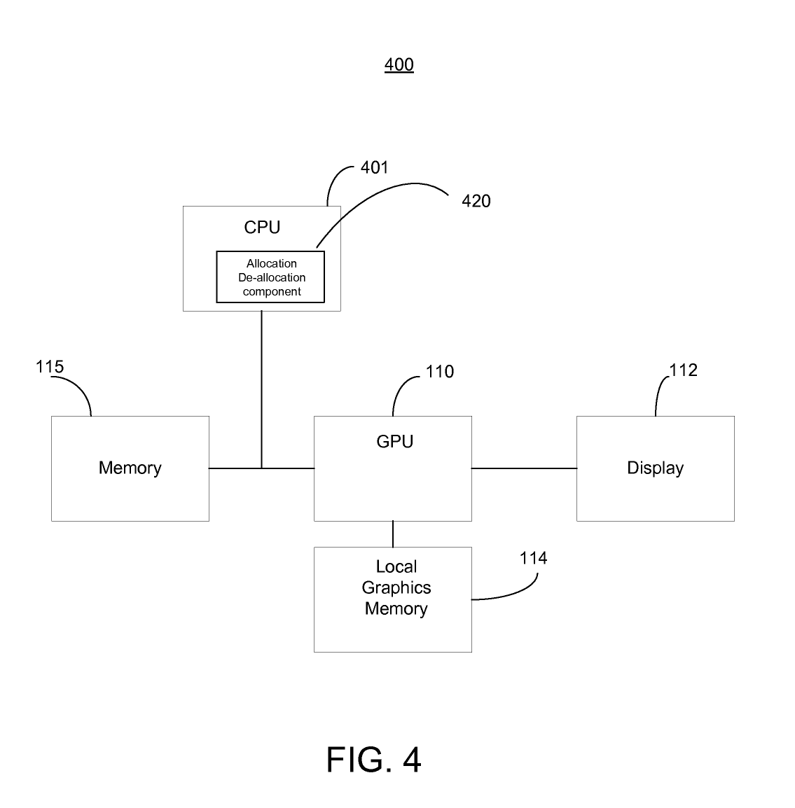

FIG. 4 shows a computer system 400 in accordance with one embodiment of the present invention. Computer system 400 is substantially similar to computer system 100 described in FIG. 1. However, computer system 400 includes a multithreaded CPU 401 that has included therein a register allocation and de-allocation component 420 that implements the just-in-time register allocation functionality. As described above, the register allocation and de-allocation component 420 dynamically allocate registers to a thread when they will be written (e.g., as opposed to when the thread is created), and de-allocate registers that are not currently needed so that the registers can be allocated to other threads.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for allocating and de-allocating registers of a processor, comprising:
a register file having plurality of physical registers;
a first table coupled to the register file for mapping virtual register IDs to physical register IDs;
a second table coupled to the register file for determining whether a virtual register ID has a physical register mapped to it in a cycle; and
wherein the first table and the second table enable physical registers of the register file to be allocated and de-allocated on a cycle-by-cycle basis to support execution of instructions by a processor.

2. The system of claim 1, wherein a size of the register file corresponds to an average utilization across multiple threads executing on the processor, wherein the allocating and de-allocating of the physical registers is configured to support threads having an above-average utilization.

3. The system of claim 1, wherein the processor is a multithreaded GPU (graphics processing unit).

4. The system of claim 1, wherein the processor is a multithreaded CPU (central processor unit).

5. The system of claim 1, wherein the processor is a strictly in-order processor, and wherein physical registers are de-allocated when an instruction writes a new value in a logical register the instruction has been assigned to.

6. The system of claim 1, wherein the processor is an out-of-order processor and further includes a third table for tracking a number of consumers of data contents of a logical register to ensure that the last consumer of a previous value of a logical register has already issued.

7. The system of claim 1, further comprising:
a fourth table for tracking a number of free physical registers, wherein upon an instruction using a given physical register issuing, the given physical register is tracked as free by the fourth table.

8. A computer system, comprising:
a system memory;
a central processor unit coupled to the system memory; and
a graphics processor unit communicatively coupled to the central processor unit, the graphics processor further comprising:
a register file having plurality of physical registers;
a first table coupled to the register file for mapping virtual register IDs to physical register IDs;
a second table coupled to the register file for determining whether a virtual register ID has a physical register mapped to it in a cycle; and
wherein the first table and the second table enable physical registers of the register file to be allocated and de-allocated on a cycle-by-cycle basis to support execution of instructions by a processor.

9. The computer system of claim 8, wherein a size of the register file corresponds to an average utilization across multiple threads executing on the processor, wherein the allocating and de-allocating of the physical registers is configured to support threads having an above-average utilization.

10. The computer system of claim 8, wherein the processor is a multithreaded GPU (graphics processing unit).

11. The computer system of claim 8, wherein the processor is a strictly in-order processor, and wherein physical registers are de-allocated when an instruction writes a new value in a logical register the instruction has been assigned to.

12. The computer system of claim 8, wherein the processor is an out-of-order processor and further includes a third table for tracking a number of consumers of data contents of a logical register to ensure that the last consumer of a previous value of a logical register has already issued.

13. The computer system of claim 8, further comprising:
a fourth table for tracking a number of free physical registers, wherein upon an instruction using a given physical register issuing, the given physical register is tracked as free by the fourth table.

14. A computer system, comprising:
a system memory;
a central processor unit coupled to the system memory, the central processor further comprising:
a register file having plurality of physical registers;
a first table coupled to the register file for mapping virtual register IDs to physical register IDs;
a second table coupled to the register file for determining whether a virtual register ID has a physical register mapped to it in a cycle; and
wherein the first table and the second table enable physical registers of the register file to be allocated and de-allocated on a cycle-by-cycle basis to support execution of instructions by a processor.

15. The computer system of claim 14, wherein a size of the register file corresponds to an average utilization across multiple threads executing on the processor, wherein the allocating and de-allocating of the physical registers is configured to support threads having an above-average utilization.

16. The computer system of claim 14, wherein the processor is a strictly in-order processor, and wherein physical registers are de-allocated when an instruction writes a new value in a logical register the instruction has been assigned to.

17. The computer system of claim 14, wherein the processor is an out-of-order processor and further includes a third table for tracking a number of consumers of data contents of a logical register to ensure that the last consumer of a previous value of a logical register has already issued.

18. The computer system of claim 14, further comprising:
a fourth table for tracking a number of free physical registers, wherein upon an instruction using a given physical register issuing, the given physical register is tracked as free by the fourth table.
